(19) United States
(12) Patent Application Publication
(10) Pub. No.: US 2024/0341523 A1
(43) Pub. Date: Oct. 17, 2024

(54) COFFEE MONITORING SYSTEM AND RELATED METHOD

(71) Applicant: Miso Robotics, Inc., Pasadena, CA (US)

(72) Inventors: Christopher Charles Kruger, Pasadena, CA (US); Aman Virmani, Alhambra, CA (US); Jorge Echeverria, Pasadena, CA (US); Fredrik Chen, Alhambra, CA (US); Nima Ashraf, Glendale, CA (US); Manuel Pimentel Ochoa, Pico Rivera, CA (US); Robert Anderson, Pasadena, CA (US); Bachir Kharraja, Pasadena, CA (US)

(21) Appl. No.: 18/627,873

(22) Filed: Apr. 5, 2024

Related U.S. Application Data
(60) Provisional application No. 63/458,596, filed on Apr. 11, 2023.

(51) Int. Cl. A47J 31/52

(52) U.S. Cl. CPC A47J 31/5253; A47J 31/521; A47J 2202/00

(57) ABSTRACT

A coffee monitoring system for monitoring coffee in an urn comprises a temperature sensor removably installed in the urn, a weight sensor arranged under the urn, and a computer programmed and operable to compute a coffee forecast based on the temperature and weight data and age of the coffee since brewing. The system includes one or more portable computing devices, preferably tablets, to conveniently communicate with users. Related methods are also described.

### CROSS-REFERENCE TO RELATED APPLICATIONS

This application claims priority to provisional application No. 63/458,596, filed Apr. 11, 2023, and entitled “COFFEE MONITORING SYSTEM AND RELATED METHOD.”.

### BACKGROUND OF THE INVENTION

This invention relates to kitchen apparatuses to assist with preparing food, and in particular to apparatuses for monitoring coffee servers in a restaurant kitchen environment.

High quality fresh coffee is very desirable in a commercial restaurant. In a typical commercial restaurant, the quality and status of the coffee is estimated by a worker lifting and shaking the coffee server in order to estimate how much coffee remains inside the server.

Various more sophisticated techniques exist. For example, one known technique for monitoring the amount of coffee remaining in a coffee server is to install a transparent tube on the server that is fluidly connected to the internal urn in the coffee server. The liquid level shown in the transparent tube corresponds to the level of coffee in the urn of the server. This allows the worker to observe how much coffee remains inside the coffee server.

There are several shortcomings with the transparent tube, however, not the least of which is that the worker must be in close proximity to the coffee server in order to visually observe the fluid level in the tube. The worker also needs to check the level frequently. If a rush arrives, the restaurant runs the risk of having an insufficient supply of coffee.

Monitoring the temperature of the coffee is even more burdensome. In order to monitor the temperature of the coffee, a worker must pour coffee into a cup and measure the temperature of the coffee inside the cup with a thermometer. This is time consuming, wasteful, and burdensome.

Predicting demand is also a problem for the currently available coffee servers. The worker does not know how much coffee they should brew because they do not know how much coffee shall be consumed in the future. If too much coffee is brewed, the excess coffee is wasted. If too little coffee is brewed, the worker must constantly brew and replace the coffee server-which makes the customers wait for the coffee to be brewed and prevents the worker from performing otherwise needed tasks.

Consequently, there is still a need for improved coffee monitor systems in the restaurant kitchen environment.

### SUMMARY OF THE INVENTION

In embodiments of the invention, the coffee server monitoring system comprises a base upon which the server is placed, a thermo-sensor arranged inside the urn of the server, and a computer programmed and operable to determine quantity, temperature, and freshness of the coffee in the server based on information generated by the base and thermo-sensor.

Optionally, the computer can compute a quality score for the coffee based on the monitored information including freshness, temperature.

In embodiments of the invention, the base comprises a scale operable to weigh the server and coffee contained therein. The base may be made of stainless steel and have a tile-like shape.

In embodiments of the invention, the base is operable to read an RFID tag on the urn. The RFID tag can correspond to a flavor of coffee. It is desirable to use the same specific or designated urn for each flavor of coffee (e.g. hazelnut versus French dark roast). The RFID tag can indicate the urn and thus flavor used with the urn.

In embodiments of the invention, the system further comprises a display, keyboard, laptop, smart phone or optionally, a tablet that is programmed and operable to alert or instruct the worker.

In embodiments of the invention, the computer, thermo-sensor, and base are adapted to communicate wirelessly. In a preferred embodiment, the sensors, tablet, and computer can communicate with one another via WiFi.

Examples of types of information that may be communicated to the workers include without limitation: (a) current state of coffee—e.g., how much coffee is inside each coffee server and its temperature; (b) instructions—e.g., alerting the worker when and how much coffee to brew, and (c) forecasting—e.g., how much coffee is anticipated to be consumed or needed. In embodiments, the forecasting is performed by a machine learning model based on previous consumption rates. The coffee forecasting model is operable to predict when the worker should brew the coffee, and the amount of coffee to brew.

The mode of communicating information to the worker may vary. In embodiments, the information is provided to the worker via a display. For example, the system is operable to provide information to the worker via a display, a tablet, smart phone, or laptop.

In embodiments, the system includes a remote virtual or cloud server, operable to communicate with the other components of the coffee monitoring station at one or more of the restaurants. The status of the coffee may be accessed by any registered worker having a web browser.

The system also processes all the gathered data and creates dashboards that can be used to understand the coffee stores' performance, track inventory, train new employees, and understand behavior patterns.

In embodiments of the invention, a coffee server monitoring system is operable to process physical parameters to monitor the quality and consumption of beverages, and optionally, to forecast consumption and suggest actions to (or alert) the worker.

In embodiments of the invention, a non-transitory storage medium for monitoring coffee in an urn comprises a set of computer-readable instructions stored thereon for computing a coffee forecast based on the temperature data, weight data, and optionally coffee age.

Embodiments of the invention have a number of objects and advantages. For example, in embodiments of the invention, the worker does not need to track or constantly check the coffee servers, less coffee is wasted, and fresh hot coffee is always available.

The description, objects and advantages of the present invention will become apparent from the detailed description to follow, together with the accompanying drawings.

### BRIEF DESCRIPTION OF THE DRAWINGS

FIG. 1 illustrates a coffee monitoring system in accordance with an embodiment of the invention;

FIGS. 2-3 are perspective views sequentially showing arranging the temperature sensor assembly with the weight sensor assembly in accordance with an embodiment of the invention;

FIGS. 4-5 are partial enlarged perspective views sequentially showing connecting a temperature sensor connector to a weight sensor port in accordance with an embodiment of the invention;

FIGS. 6A-6C sequentially illustrate installing the weight and temperature sensor assemblies to an urn;

FIG. 7 illustrates a graphical user interface of a coffee brewing station display in accordance with an embodiment of the invention;

FIG. 8 illustrates examples of GUI coffee status indicators in accordance with an embodiment of the invention;

FIG. 9 illustrates a graphical user interface of a coffee monitoring station display in accordance with an embodiment of the invention;

FIG. 10 is a schematic diagram of the coffee monitoring system in accordance with an embodiment of the invention;

FIG. 11 is a system diagram showing various computing nodes of a coffee monitoring system in accordance with embodiments of the invention;

FIG. 12 is a flow diagram of a method for monitoring coffee in accordance with an embodiment of the invention; and

FIG. 13 is a flow diagram of another method including a machine learning algorithm for monitoring coffee in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### Apparatus Overview

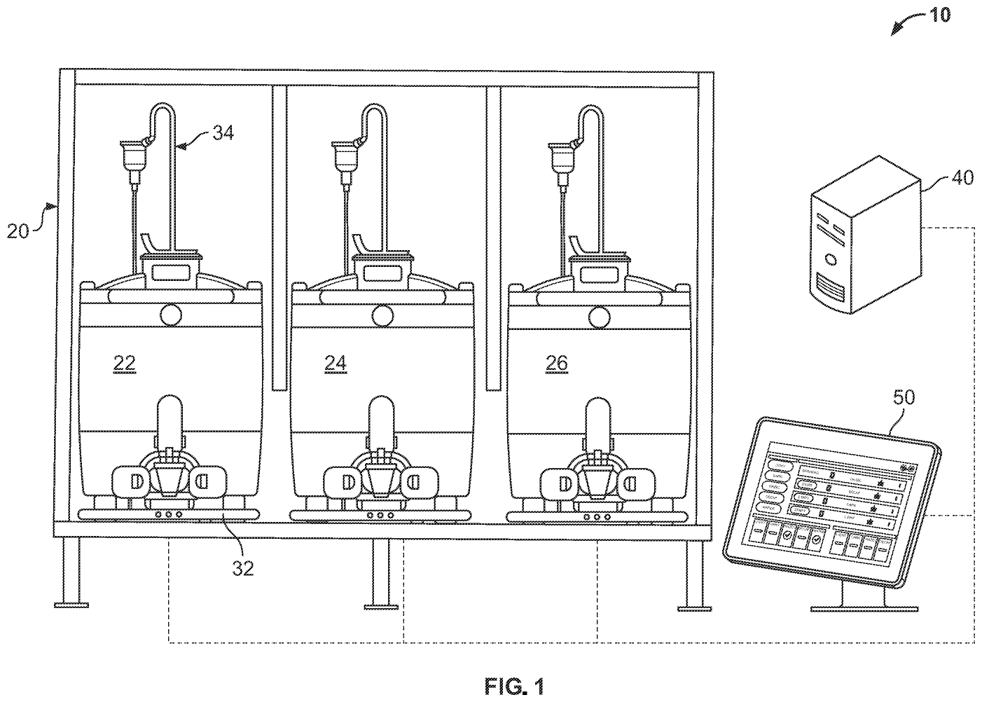

FIG. 1 is an illustration of a coffee monitoring system 10 for monitoring the coffee in accordance with one embodiment of the invention.

System 10 is shown having a coffee station 20 including three coffee servers 22, 24, and 26. A dedicated weight sensor unit 32 and a temperature sensor assembly 34 are provided for each coffee server 22, 24, and 26.

System 10 is also shown comprising a computer 40 to house a processor(s) and other hardware which are operable, as described further herein, to receive data from the sensors, process the data, and send the data to one or more portable computing devices (e.g., a tablet 50, smart watch, laptop, or smart phone).

As described herein, in embodiments of the invention, the tablet 50 is programmed and operable with software (e.g., an “App”) to wirelessly (or through a wired connection) communicate with the processor, accept input from the user, and to send or display various information as described further herein. Nonlimiting examples of types of information that can be displayed include coffee status (e.g., full, ½ full, temperature, need to refill, temperature, etc.), forecast, and brewing instructions.

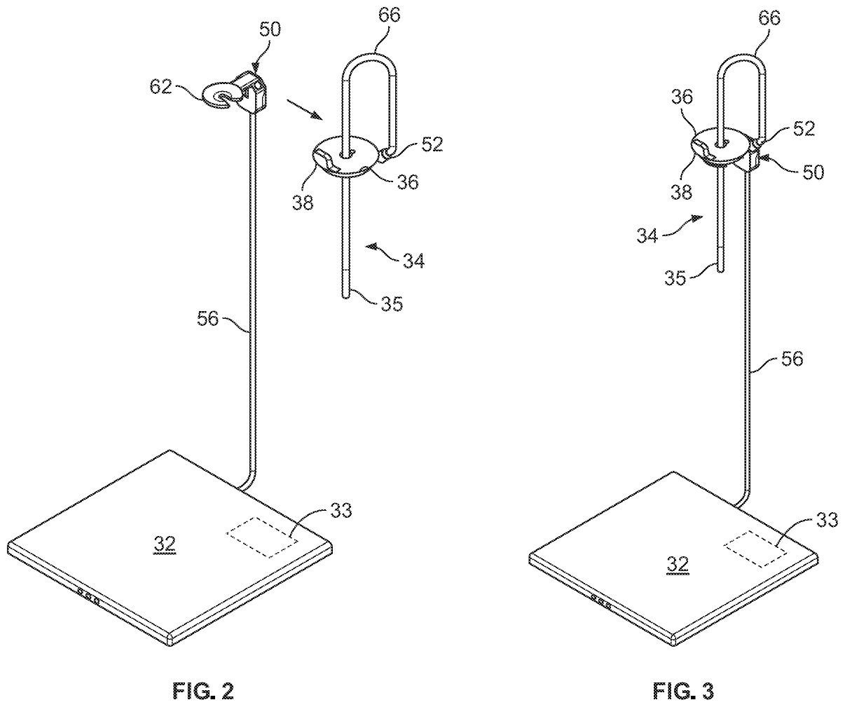

FIGS. 2-3 sequentially illustrate connecting the weight sensor unit 32 and temperature sensor assembly 34 to one another via a magnetic connector 50 in accordance with an embodiment of the invention.

Weight sensor unit 32 is shown having a flat square shape. It includes an upper surface on which a coffee server may be placed. The weight sensor unit 32 is adapted to measure the weight of the coffee server (and coffee) when placed thereon. Preferably, the weight sensor unit 32 is a smart scale-type device and includes onboard electronics and software 33 to receive, process, record, and transfer data with ancillary devices whether wirelessly or wired. In the embodiment, shown in FIGS. 2-3, and as discussed further herein, extension cable 56 connects magnetic connector to the weight sensor unit 32. A preferred weight sensor unit is the Sensorcon SC134 Half Bridge 10 KG, manufactured by Sensorcon. However, other weight sensors can be used and the invention is not intended to be so limited except where excluded by any of the appended claims.

Temperature sensor assembly 34 is shown having a temperature sensor 35, coffee server cap 36 which holds the temperature sensor within the urn of the coffee server when the cap is placed on the server, and loop conductor 66 which terminates in magnetic end 52. A lip or handle 38 is shown on the cap for the worker to manipulate the temperature assembly 34. Examples of suitable temperature sensors include, without limitation, thermocouples and thermistors. A preferred thermocouple is the Senstech CWF-C9, manufactured by Senstech (Guangdong, China). However, it is to be understood that other sensors may be incorporated in the invention except where excluded by any appended claims.

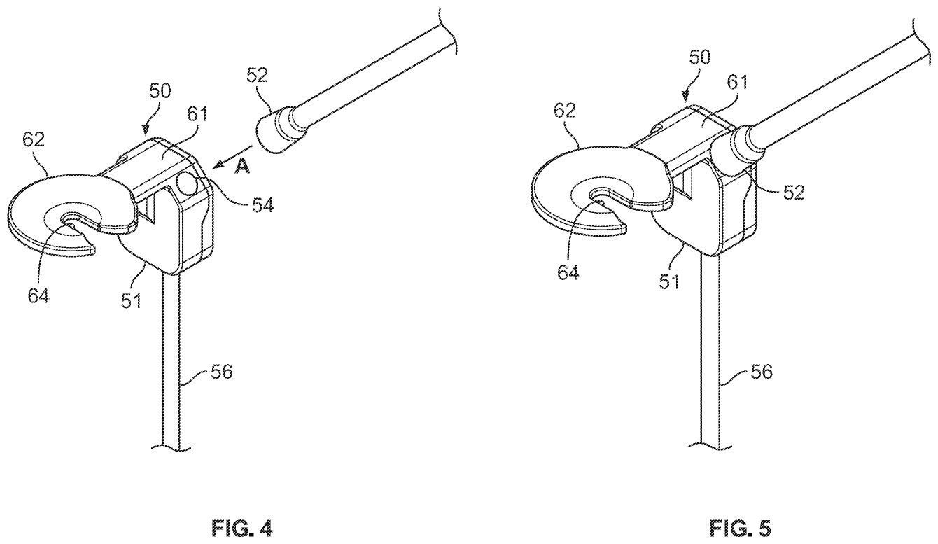

FIGS. 4-5 are enlarged views of the magnetic connector end 52 being coupled to the magnetic connector 50.

Magnetic connector 50 is shown including a body 51, adapted to be mounted or affixed to the coffee station (e.g., station 20 shown in FIG. 1). The connector 50 may include flat back with openings for fasteners, or may include Velcro or other nonpermanent adhesives to join the connector 50 to a rigid support in the coffee station enclosure or cabinet.

With reference to FIG. 4, the connector end 52 is shown being advanced (A) onto circular opening or port 54 in the magnetic connector 50. Once within the near proximity to opening 54, the end 52 is automatically aligned and coupled to the opening 54 due to magnetic force as shown in FIG. 5. Examples of suitable magnetic connectors include, without limitation, Adam Tech PHR-C4777-02-FVP-800, Adam Tech CA-ST2-PHR-198-M, both of which are manufactured by Adam Tech (Union, New Jersey).

The magnetic connector 50 is also shown including a hanger 62 adapted to hold the temperature sensor assembly 34 while the coffee server is removed for brewing, discussed herein. The hanger 62 is attached to the magnetic connector via arm 61, and includes a slot 64 to receive a portion of the temperature sensor assembly 34.

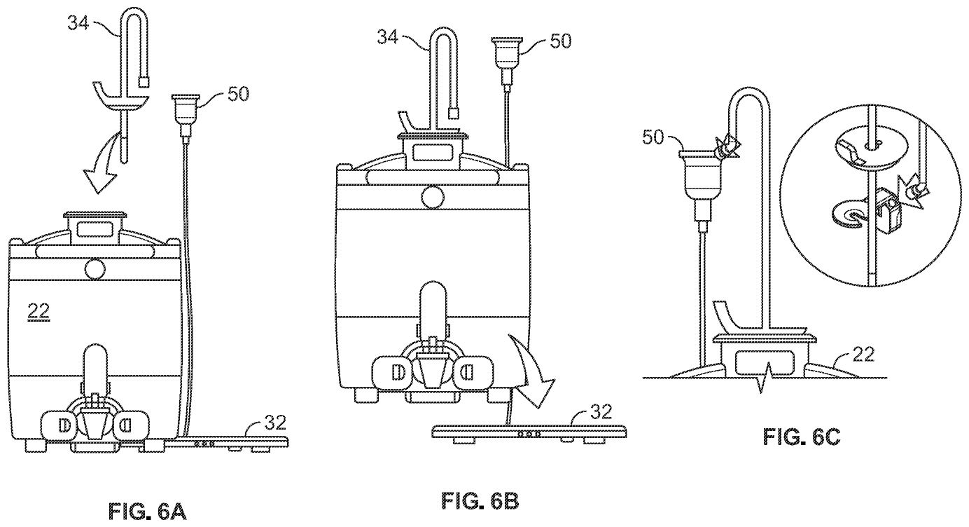

FIGS. 6A-6C illustrate sequentially installing the temperature sensor assembly 34 in a coffee server 22 such that the cap covers the urn's opening, placing the coffee server onto the weight sensor unit 32, and coupling the temperature sensor assembly to the weight sensor unit via connector 50, as described above.

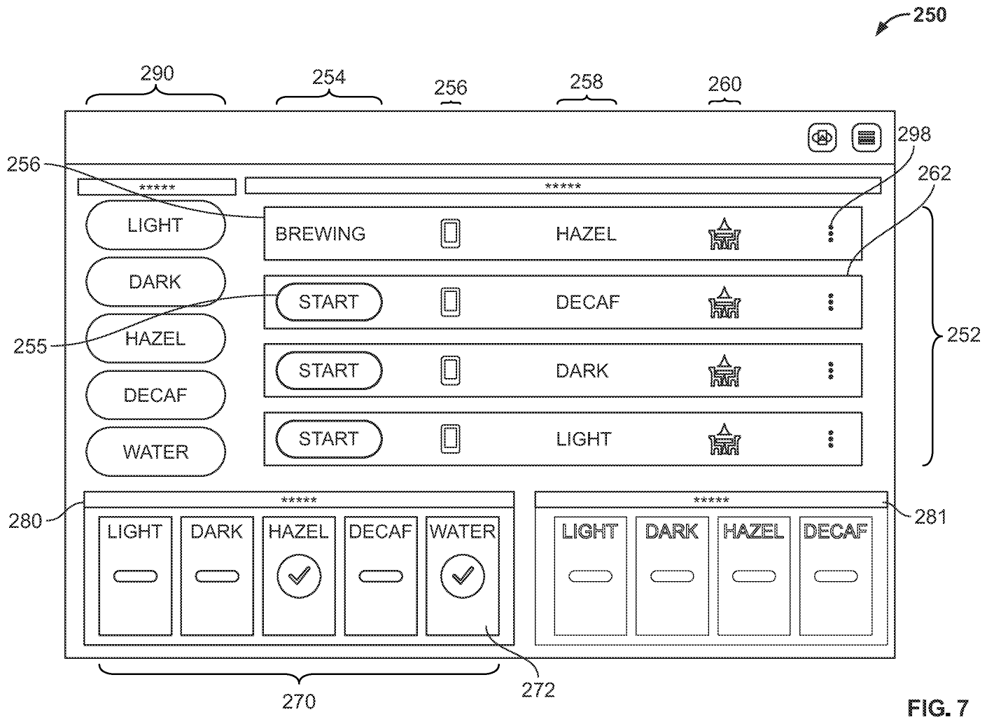

FIG. 7 is a GUI of a coffee brewing station display 250 in accordance with an embodiment of the invention. As described further herein, the coffee brewing station display 250 is presented on a tablet or computer, in the vicinity of the coffee brewers which typically are located at the front-of-house or back-of-house location, and preferably adjacent to the coffee brewers themselves. Urns are prepared and put into brewers per normal brewer procedure so the urns are ready for brewing when it comes time to start brewing, discussed herein.

Coffee brewing display 250 is shown comprising a brew queue 252, cards 270 associated with a room 280, and option 290 to add an urn to the brew queue.

Brew queue 252 shows a plurality of rows corresponding to coffee urns. Each row has a column for user instruction 254, target amount 256, brew type 258, and target room 260.

In embodiments of the invention, user instructions 254 include various commands such as, for example, ‘START’, ‘BREWING’, and ‘SWAP’.

When the urn is in position in the brewer, the user commences brewing of an urn by pressing the ‘START’ button 255 next to the desired urn in the brew queue 252. When brewing is started, the system is programmed and operable to (a) start a timer that can be used to compute when brewing is finished (e.g., XX-minutes), and when the coffee should be replaced to maintain freshness (e.g., 70 minutes), discussed further herein, and (b) replace the ‘START’ button with an in-brew type indicator (e.g., ‘BREWING’ 256). A progress bar 262 will show the remaining time until the brewing process is complete.

When an urn is finished brewing and is ready to be placed inside the coffee station cabinet, described above, the user instruction will replace ‘BREWING’ with a transfer instruction such as, e.g., ‘SWAP’. Optionally, the instruction may be presented in a different color than the other instructions and can be highlighted or flash to better obtain the user's attention.

As many urns can be brewed and added to the brew queue as there are brewers.

If all brewers are currently in use, the user instructions are disabled for items in the queue that are not at brewing stations. For example, in embodiments, when the START button is disabled, it is grayed-out on the display such that the user cannot press it.

Each urn listed in the brew queue also shows the target amount 256. For example, an urn or container icon can be presented to indicate a half or full urn is desired.

Each urn listed in the brew queue also shows the brew type 258. Examples of brew types include, without limitation, Hazel, water, decaf, dark, light, French, Espresso, etc.

Each urn listed in the brew queue also shows the target room 260. For example, a room icon can be presented to indicate which room the urn is to be placed when brewing is complete. Examples of target rooms include, without limitation, dining room and drive-thru.

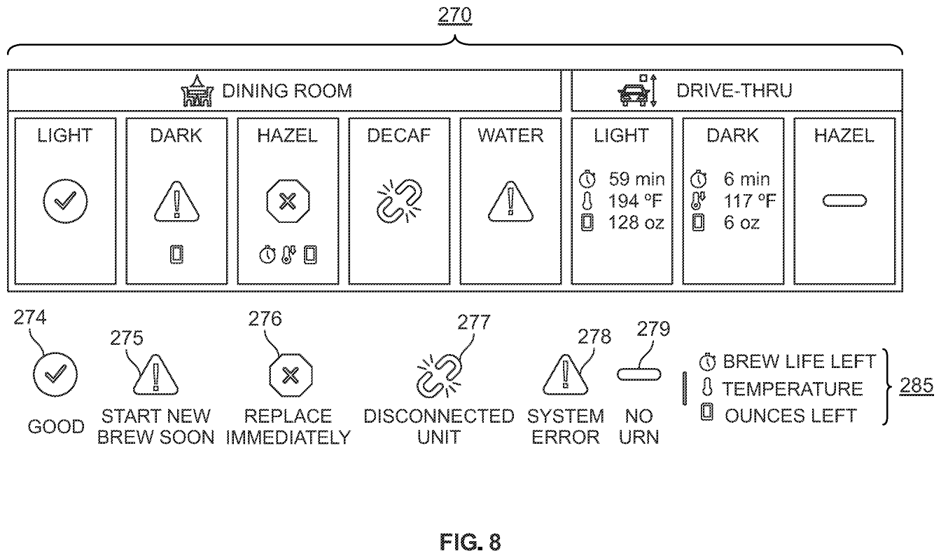

The brewing station display 250 also shows a plurality of cards 270 associated with rooms 280, 281. Each urn is represented by a card (e.g., card 272) and lists the brew type and status. Examples of default status icons are shown in FIG. 8 and include, without limitation, a green encircled check mark symbol 274 for good/adequate, a yellow hazard-like exclamation point 275 for start new brew soon, a red stop-like cross 276 for replace immediately, a broken loop 277 for a disconnected unit, a red hazard-like exclamation point 278 for system error, and a gray fill shape 279 for no urn. However, it is to be understood that the shape, color, and text of the icons may vary and the invention is not intended to be limited except where recited in any appended claims.

Additionally, in embodiments, the system is programmed and operable to, if you tap on the “card” of an urn, to present more details/data underlying the status of the urn. Examples of status details/data 285 are shown in FIG. 8 and include the brew life left (e.g., the computed difference between the predetermined brew life maximum versus the time since brewing was commenced), current temperature of coffee in the urn, and amount of coffee remaining in urn.

The brewing station display 250 also shows a tab 290 for the user to manually add an urn to be brewed to the brew queue 252. In embodiments, the system is programmed and operable to allow the user to select the type of beverage from the list of buttons in the option area 290.

If there is more than one room, the system will provide a pop-out menu to select a room. For example, the user may select ‘Dining Room’ or ‘DRIVE-THRU’.

The urn is now at the top of the brew queue 252. The START button will be replaced by BREWING when the Start button is pressed as described above. A progress bar 262 will show the remaining time until the brewing process is complete. Optionally, the urn may be marked or denoted that it was manually added. The Drive-Thru icon is presented in the target room column 260. Then, once the brewing is completed, the urn is taken to the coffee station/cabinet as described above.

The presence of the urn is automatically sensed when it is properly arranged in position in the coffee station, and the brew queue is updated to disable the urn from being started. Simultaneously, the corresponding card 272 in the room is automatically updated to reflect the instant status of the urn.

FIG. 7 also shows an options icon 298 for performing additional tasks including, e.g., resetting a timer or removing an item from the brew queue.

In embodiments, the system is programmed and operable to provide a popout dialog box querying whether the user desires to reset the timer or remove the item from the queue.

To reset the timer, tap the corresponding button and the item will be moved to the top of the queue. Then, START will need to be pressed again to begin a new brew cycle for the urn.

To remove an item from the brew queue, tap the corresponding button and the item will be deleted from the brew queue.

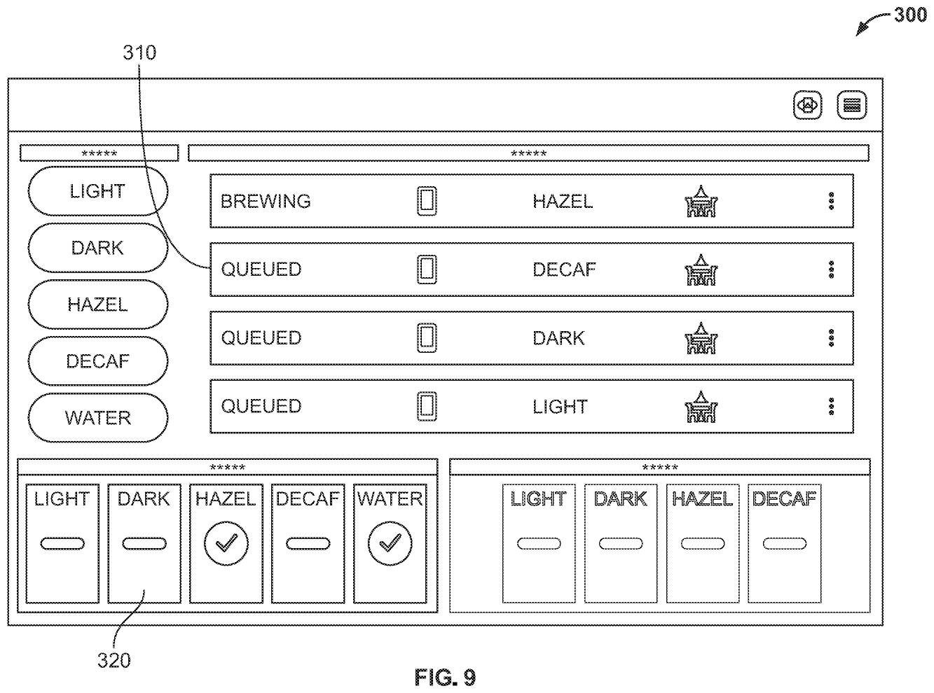

FIG. 9 is a GUI of a coffee monitoring station display 300 in accordance with an embodiment of the invention. The coffee monitoring station display 300 is optional and intended to be placed in the vicinity of POS or drive-thru. The coffee monitoring display 300 can be similar to the coffee brewing station display 250, described above, except that the coffee monitoring station cannot ‘START’ brewing. The ‘START’ brewing may only be commenced on the brewing station tablet, discussed above. An urn 310 that is waiting to be brewed is shown as ‘QUEUED’ on the monitoring display 300 rather than an (e.g., urn 255) which is shown as ‘START’ on the brewing display 250. Card 320 also indicates when an urn is not present on the coffee station. As shown in FIG. 9, Decaf, Dark and Light are shown in the brew queue as ‘QUEUED’ and the corresponding cards in the room reflects urns are not present in the coffee station.

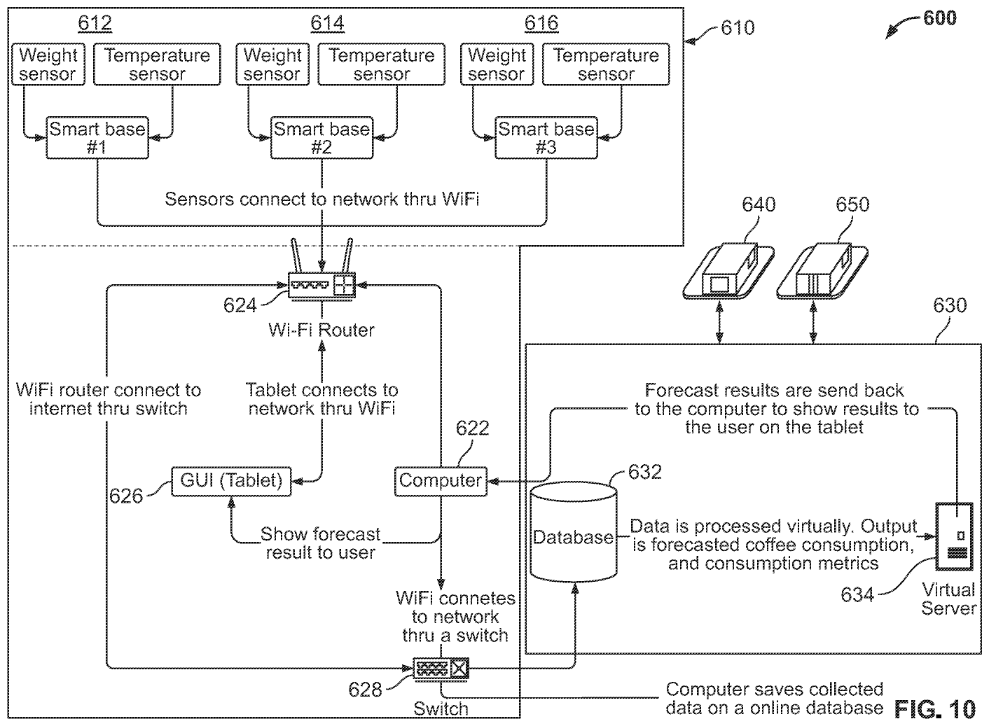

FIG. 10 is a schematic diagram of a coffee monitoring and brewing system 600 in accordance with an embodiment of the invention. System 600 is shown including a sensor framework 610 arranged to obtain various data from the coffee stations as described above; at least one computer 622 for processing the sensor data and performing other functionality as described herein; at least one tablet 626 (or another type of display or portable computing device) operable to provide the graphical user interfaces described herein; a wi-fi router 624 for wirelessly connecting the sensor framework, computer and tablets to one another, and a switch 628 to connect to the internet through the restaurant's service provider.

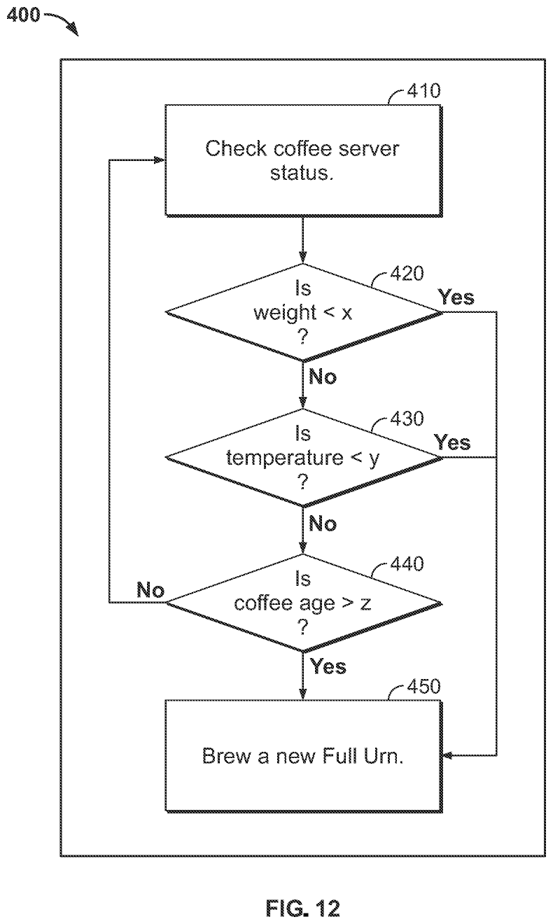

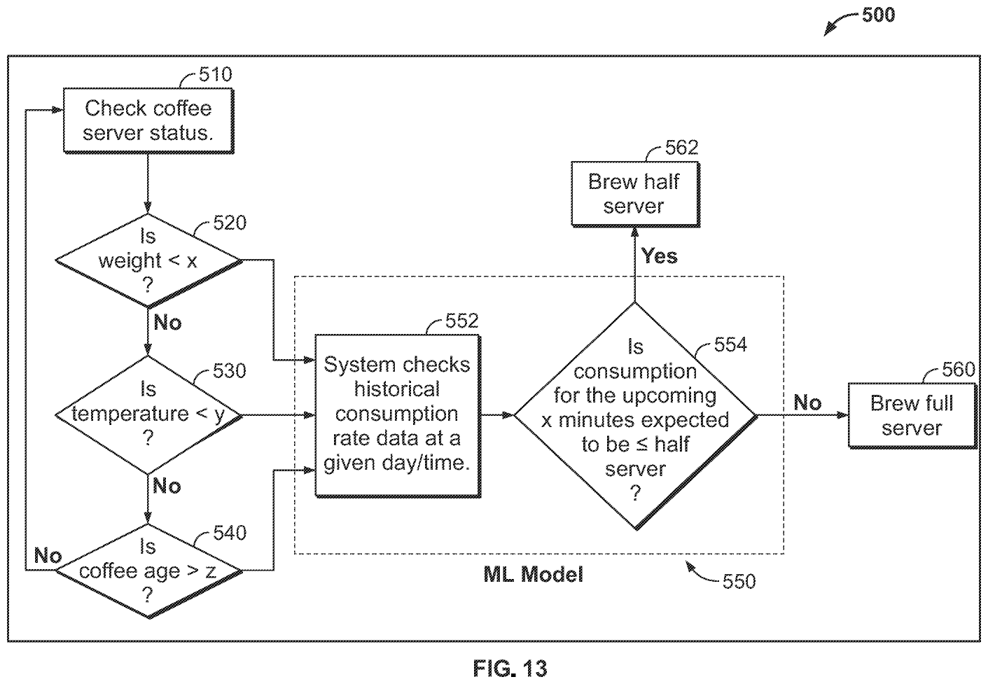

Amongst other functionality, the computer 622 is programmed to compute coffee supply forecast based on the data from the sensor stations 612, 614, and 616. Exemplary forecast models are described herein in connection with FIGS. 12, 13.

Optionally, and as shown in FIG. 10, data can be sent to an online database 632 and processed virtually by a remote server 634. The online database 632 and virtual server 634 may be arranged to communicate with a plurality of coffee monitoring systems 610, 640, 650 from different restaurants. The virtual server 634 can be programmed to compute coffee supply forecast based on local and/or global data and trends. Indeed, the more data captured and evaluated, the more accurate a forecast model (e.g., a machine learning model) can be built, as described further herein with reference to FIG. 13.

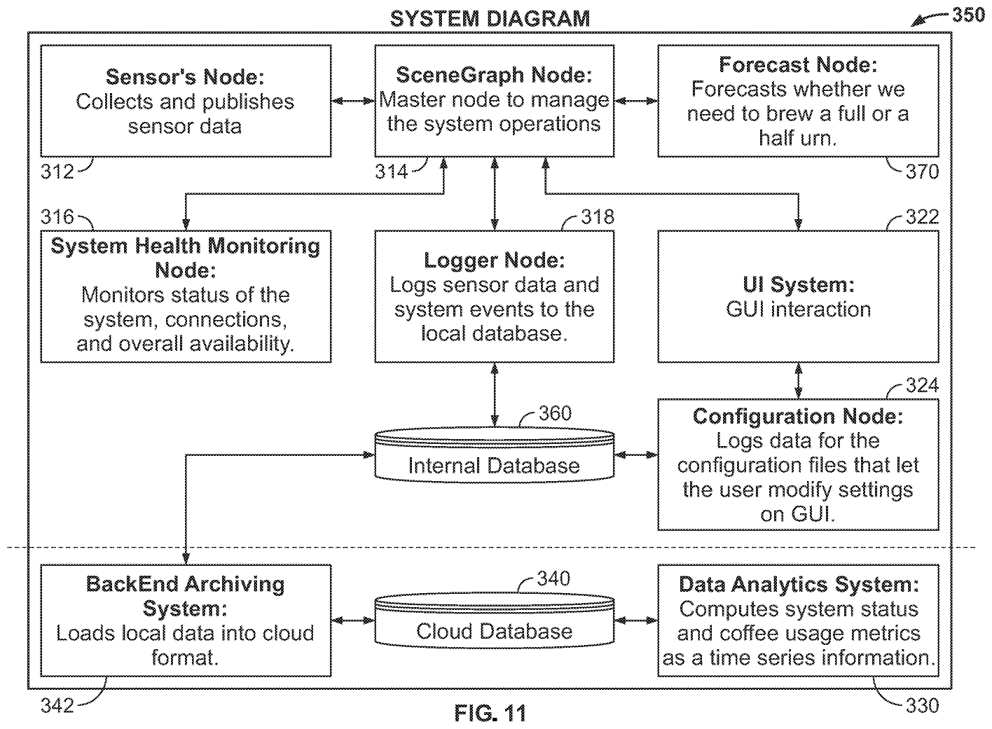

FIG. 11 is a system diagram of a coffee monitoring system 350 in accordance with an embodiment of the invention. The system 350 is shown including an onboard or internal database 360 and a plurality of nodes or modules programmed and operable to carry out the functionalities described herein.

Sensor node 312 collects and publishes sensor data received from the sensors described above. Sensor node can include the smart base 33 as illustrated in FIGS. 2-3 which is operable to send the data to master node 314.

Master or Scenegraph Node 314 manages the system operations. Examples of operations managed by master node include without limitation, providing output to the UI and scheduling system operations such as logging, forecasting, etc.

System health node 316 monitors the status of the system, connections, and overall availability. For example, the system health node can monitor the status of the smart base (e.g., is the base connected/disconnected, is an urn placed/urn removed, etc.). Additionally, system health node can evaluate and monitor if the base needs to be calibrated.

Logger node 318 records sensor data and system events to the local database 360.

Configuration node 324 records data for the configuration files that let the user modify settings on GUI (e.g., adding or removing an urn from the brew queue, etc.), described herein.

UI system 322 is a user interface system for communicating with the user. Examples of components of the UI system include keyboards, displays, as well as programmed portable computing devices such as tablets and smartphones having programmed thereon Apps for carrying out the coffee brewing and monitoring functionalities discussed herein.

Optionally, the system includes a cloud database 340 for storing data to the cloud via archiving system 342. In embodiments, a data analytics system 330 computes the system status and coffee usage metrics as time series information. Examples of system status and coffee usage metrics include information about coffee weight and temperature for different base units as a function of time. It can also include system status information such as connectivity, usage (in_use/not_in_use).

System 350 also shows forecast node 370. The forecast node is programmed and operable to predict when, and optionally, how much coffee to brew.

With reference to FIG. 12, a coffee forecasting method 400 in accordance with an embodiment of the invention is illustrated. The method 400 can be performed by the coffee forecast node, computer and electronics, described above.

Step 410 states to check coffee server status. This step is performed automatically when the coffee brewing and monitoring system is activated, and an urn is installed in a brewing cabinet or station as described above. The method 400 then proceeds to step 420.

Step 420 states to query whether the weight is less than a predetermined weight X? An exemplary range for X is from 6 fl oz to 24 fl oz. If the weight is less than the predetermined weight, the user is instructed to brew a new urn 450. If not, the method proceeds to the next step 430.

Step 430 states to query whether the temperature is less than a predetermined temperature Y? An exemplary range for Y is from 167 to 202 degrees F. If the temperature is less than the predetermined temperature, then the user is instructed to brew a new urn 450. If not, the method proceeds to the next step 440.

Step 440 states to query whether the coffee age is greater than a predetermined maximum coffee age? An exemplary range for the maximum coffee age is 5 to 120 minutes. If the measured coffee age is greater than the predetermined maximum coffee age, then the user is instructed to brew a new urn 450. If not, the method returns to step 410.

The method 400 can be performed automatically and regularly. In embodiments, the method 400 is performed continuously. The order of the steps 420, 430, 440 may vary. Steps 420, 430, 440 may be performed in sequence or in parallel. Additionally, one or more of the steps 420, 430, 440 may be omitted so long as at least one step 420, 430, 440 is present.

With reference to FIG. 13, a coffee forecasting method 500 in accordance with another embodiment of the invention is illustrated. The method 500 can be performed by the coffee forecast node, computer and electronics, described above.

Step 510 states to check coffee server status. This step is performed automatically when the coffee brewing and monitoring system is activated, and an urn is installed in a brewing cabinet or station as described above. The method 500 then proceeds to step 520.

Step 520 states to query whether the weight is less than a predetermined weight X? An exemplary range for X is from 6 fl oz to 24 fl oz. If the weight is less than the predetermined weight, the method proceeds to step 550. If not, the method proceeds to the next step 530.

Step 530 states to query whether the temperature is less than a predetermined temperature Y? An exemplary range for Y is from 167 to 202 degrees F. If the temperature is less than the predetermined temperature, then the method proceeds to step 550. If not, the method proceeds to the next step 540.

Step 540 states to query whether the coffee age is greater than a predetermined maximum coffee age? An exemplary range for the maximum coffee age is 5 to 120 minutes. If the measured coffee age is greater than the predetermined maximum coffee age, then the method proceeds to step 550. If not, the method returns to step 510.

Step 550 determines the quantity of coffee to brew. In the embodiment shown in FIG. 13, step 550 determines whether to brew a full or half server. This step can be performed by the forecast node, computer and electronics, described herein.

Step 552 checks historical consumption rate data for a given day and time.

Step 554 computes, based on the historical consumption rate data from step 552, whether the consumption rate for the upcoming X minutes is expected to be less than half server, where X ranges from 0 to 120 minutes. If not, the method proceeds to step 560. If yes, the method proceeds to step 562.

In embodiments, step 550 is performed using a machine learning model. The model may be a supervised-type learning model based on coffee consumption data for different days, times, months, locations as recorded to the online database. The model may be trained to classify the quantity of coffee needed per upcoming minutes based on the trained model. Then, the trained model can be downloaded to the local computer in the restaurant. Examples of machine learning models which can be trained include, without limitation, neural networks, decision trees, linear or polynomial regressions.

Additionally, in embodiments, an unsupervised learning algorithm is employed such as, e.g., hidden Markov model, or LSTM. The unsupervised model has the advantage of being trained with less human supervision. Additionally, in embodiments, a “continuous” amount (e.g., Z oz) of the coffee needed is output rather than fixed categories (e.g., full or half server). Additionally, it is to be understood that the coffee forecasting models described herein can be based on a wide range of inputs including but not limited to location, time zone, time of the year, and customer information.

Step 560 states to instruct the user to brew full server. As described herein, this step may be performed by sending an instruction to a tablet at the coffee brewing or monitoring stations.

Step 562 states to instruct the user to brew half server. As described herein, this step may be performed by sending an instruction to a tablet at the coffee brewing or monitoring stations.

The method 500 can be performed automatically and regularly. In embodiments, the method 500 is performed continuously. The order of the steps 520, 530, 540 may vary. Steps 520, 530, 540 may be performed in sequence or in parallel. Additionally, one or more of the steps 520, 530, 540 may be omitted so long as at least one step 520, 530, 540 is present.

In embodiments, the system includes a self-cleaning module. In embodiments, the self-cleaning module includes software and hardware for flushing hot water inside the server/urn, optionally, performed on a schedule (day/time) or after a number of orders has been completed (e.g., 50 orders).

In embodiments, the temperature and weight measurement data are preprocessed in order to reduce noise to obtain more accurate measurements of the coffee in the urn. One or more logic rules are applied during temperature and weight sensing. In embodiments, the pressing action of the coffee urn lever to dispense coffee is characterized (recognized) and excluded. For example, as the lever is pressed, the weight signal can fluctuate and increase for a period of time relating to the length of time the user presses the handle. Once released, the handle returns to home position, and the weight of the beverage and sensor stabilizes. In embodiments, the system is programmed to detect fluctuations in weight over time arising from the handle versus the beverage contained within the urn. In embodiments, a weight signal measurement that varies within a few seconds is considered an anomaly and the detection module is programmed to exclude this type of data. This detector algorithm serves to detect real beverage weight as opposed to weight fluctuations arising from quick handle movement or urn motion.

### Alternative Embodiments

In embodiments, volume of the coffee in the urn can be detected by detecting the liquid level from the bottom or top of the urn. In embodiments, a laser or light is directed at the upper surface of the coffee within the urn. Reflected light is detected and the sensor is calibrated to predict the volume of liquid in the urn based on the reflected light. In other embodiments, a camera is aimed at the coffee level window, and obtains images of the coffee liquid level. The images can be processed and analyzed to determine the coffee volume.

The invention described herein is not intended to be limited to coffee except where specifically recited in any appended claims. The components and steps can be used to monitor other beverages such as tea, soda, mixers, shakes, cold beverages, hot beverages, and raw or fresh room temperature beverages. As described above, volume, temperature, and age can be used in combination or independently to monitor the beverage.

In addition to (or in lieu of) the tablet described above, the computer may be programmed and operable to send commands, alerts, and information to the kitchen worker via a display or in some embodiments via speakers.

In embodiments, the computer is programmed to compute a quality score or level of the beverage in the server. The score can be based on one or more of the recorded data. Additionally, the system can be programmed and operable to accept input from the user to weight one type of data higher than another type of data.

In accordance with one embodiment of the invention, an example of a quality score (which may vary from 1 to 100 with 100 being highest quality) is:

$$Q = 100 - ( w 1 \times \frac{\vert Δ T \vert}{TU} + w 2 \times \frac{\vert Δ A \vert}{AU} ) \times 100$$

where ΔT is the difference in temperature between the predetermined undesirable temperature (TU) and the measured temperature, and ΔA is the difference between the predetermined undesirable age (AU) and the measured age, and w1 and w2 are the optional user weight factors (e.g., between 0-1) for the temperature and age, respectively.

In embodiments, the system GUI is designed to support multi-languages.

In embodiments, the system includes an internal self-monitoring diagnostic module to monitor the health of the device. The system can be further programmed and operable to alert operators if any changes are needed to optimize operation.

Still other modifications and variations can be made to the disclosed embodiments without departing from the subject invention.

We claim:

1. A method for monitoring coffee in an urn, the method comprising:
receiving temperature data from a temperature sensor installed in the urn;
receiving weight data from a weight sensor arranged under the urn; and
computing a coffee forecast based on the temperature data and the weight data.

2. The method of claim 1, further comprising displaying the coffee forecast.

3. The method of claim 1, further comprising evaluating the age of the coffee based on a timer started when the coffee in the urn was brewed.

4. The method of claim 3, wherein the computing step is further based on the age of the coffee.

5. The method of claim 1, further comprising providing the temperature sensor, and installing the temperature sensor in urn.

6. The method of claim 5, further comprising providing the weight sensor, and arranging the urn on the weight sensor.

7. The method of claim 6, further comprising coupling a connector of the temperature sensor to a connecting port of the weight sensor after the urn has been arranged on the weight sensor.

8. The method of claim 7, wherein the computing step is performed on a computer, and the method further comprises sending the temperature and weight data to the computer.

9. The method of claim 7, wherein the connector of the temperature sensor is a magnetic connector operable to hold the connector to the connecting port based on magnetic force.

10. The method of claim 9, further comprising sending coffee consumption rate data from multiple different restaurants to a remote server, and the computing is based on the coffee consumption rate data from the multiple different restaurants.

11. A coffee monitoring system for monitoring coffee in an urn, the system comprising:
a temperature sensor removably installed in the urn; and
a computer programmed and operable to compute a coffee forecast based on temperature data received from the temperature sensor.

12. The system of claim 11, further comprising a weight sensor arranged under the urn; and wherein the computer is programmed and operable to compute the coffee forecast based on weight data received from the weight sensor.

13. The system of claim 12, further comprising a tablet, and the tablet is operable to show the coffee forecast.

14. The system of claim 13, wherein the computer is programmed and operable to compute the coffee forecast based on age of the coffee from brewing.

15. The system of claim 11, further comprising an urn cap, and the temperature sensor is integrated with the urn cap.

16. The system of claim 15, further comprising a scale, and the weight sensor is incorporated in the scale.

17. The system of claim 16, further comprising a connecting hub extending from the scale by a cable, and wherein the hub comprises a port to receive a temperature connector from the temperature sensor.

18. The system of claim 17, further comprising processor and electronics to wirelessly send the temperature and weight data to the computer.

19. The system of claim 18, further comprising a virtual server and database for receiving and storing coffee consumption data from multiple restaurants; and for training the machine learning model.

20. The system of claim 11, further comprising a base and a flavor detector arranged in the base, and wherein the flavor detector comprises an RFID sensor to read an RFID tag on the urn corresponding to a coffee flavor.

21. The system of claim 11, further comprising a self-cleaning module for automatically rinsing the urn with a cleaning liquid, wherein the cleaning module is programmed and operable to commence cleaning the urn based on a schedule or number of uses.
